(19) United States
(12) Patent Application Publication
(10) Pub. No.: US 2019/0349664 A1
(43) Pub. Date: Nov. 14, 2019

(54) EAR PHONE SYSTEM

(71) Applicant: LeeAnn Harper, Langley (CA)

(72) Inventor: LeeAnn Harper, Langley (CA)

(21) Appl. No.: 16/409,814

(22) Filed: May 11, 2019

Related U.S. Application Data
(60) Provisional application No. 62/671,393, filed on May 14, 2018.

(51) Int. Cl. H04R 1/10

(52) U.S. Cl. CPC H04R 1/1041; H04R 2420/07; H04R 1/1016

(57) ABSTRACT

An improved ear phone system is described that addresses the shortcomings of conventional ear phone systems in regards to the annoying aspect of easily falling out of the ears during activity. An implementation, known commercially as snug phones, can provide one or more improvements over conventional ear phone systems by use of a novel placement of the speaker within the ear canal using a novel ear plug and speaker design. The described improvements are facilitated by an earbud design in concert with advancements in micro speaker design with high fidelity.

### RELATED APPLICATIONS

This application claims the benefit of U.S. Application No. 62/671,393, entitled “Improved Ear Phone System,” and filed on May 14, 2018, which is incorporated herein by reference in its entirety.

### TECHNICAL FIELD

Embodiments relate generally to earphones, and more particularly, to an improved ear phone system.

### BACKGROUND

It is well known by users of ear buds that earbuds (or in-ear earphones) frequently fall out during use, especially during activities such as exercise. As such, users may not want to use earbuds even when they offer the convenience of being able to listen to music, or talk on the phone during activity.

Conventional earbuds may not provide a way to prevent the earbuds from falling out during activity. Further, the speakers utilized in conventional earbuds typically sit to the outside of the earbud and may weigh down the earbud and result in an earbud that may fall out over time and during activities. The conventional earbud design and materials utilized may not typically be malleable to the ear of a user, which may result in earbuds that can easily fall out of the ear. Additionally, conventional earbuds may have elements that sit outside the ear canal resulting in a system that easily falls out simply because the earbuds are not secured within the ear canal and are readily pulled out by the weight of the connecting wires.

Conventional buds may be designed to fit inside larger ears and may not provide a one size fits all solution. It is well known that conventional ear buds frequently fall out of the ear and can be frustrating to the user.

### SUMMARY

Described are improvements to earbud design that may address the wants and needs of some earbud users by providing a design that does not fall out during activity. The benefit to the user of the disclosed subject matter is that once the improved ear buds, described herein, are inserted into the ear canal they are retained securely within the ear canal and do not fall out. In some implementations, the only element that is disposed on the outside of the earbud is the wire, which is very light and does not have the necessary weight or momentum during movement to pull the earbuds out of the user's ear. In some implementations, the speaker and earbud fit directly into the ear canal of the user resulting in an earbud that does not have any elements outside the portion that is disposed within the ear canal of the user, which results in a very stable earbud that is firmly held in place. Further, the described design can result in an earbud that helps block out external noise.

Some implementations can include an earphone system comprising: a first earphone; a second earphone; a control enclosure; and an energy storage enclosure. In some implementations, the first earphone can be coupled to the control enclosure, the second earphone is coupled to the energy storage enclosure, the control enclosure is coupled to the energy storage enclosure, a first wire coupled to the first earphone and a second wire coupled to the second earphone are disposed on an outside of each earphone, and a speaker within each of the first earphone and second earphone fit directly into the ear canal of a user resulting in an earphone that does not have any elements outside a portion that is disposed within the ear canal of the user, and which results in a very stable earbud that is firmly held in place in the ear canal of the user.

In some implementations, the first earphone and the second earphone help block out external noise. In some implementations, the first earphone and the second earphone are constructed to fit inside respective ear canals of a user.

In some implementations, the first earphone is coupled via a wired connection to the control enclosure. In some implementations, the second earphone is coupled via a wired connection to the energy storage enclosure.

Some implementations can include an earbud system comprising: a first earbud; a second earbud; a control enclosure; and an energy storage enclosure. In some implementations, the first earbud is coupled to the control enclosure, the second earbud is coupled to the energy storage enclosure, the control enclosure is coupled to the energy storage enclosure, a first wire coupled to the first earbud and a second wire coupled to the second earbud are disposed on an outside of the earbud, and a speaker within each of the first earbud and second earbud fit directly into the ear canal of a user resulting in an earbud that does not have any elements outside a portion that is disposed within the ear canal of the user, and which results in a very stable earbud that is firmly held in place in the ear canal of the user.

In some implementations, the first earbud and the second earbud help block out external noise. In some implementations, the first earbud and the second earbud are constructed to fit inside respective ear canals of a user. In some implementations, the first earbud is coupled via a wired connection to the control enclosure. In some implementations, the second earbud is coupled via a wired connection to the energy storage enclosure.

Some implementations can include an audio system comprising one or more integrated earbuds constructed to be fully inserted into an ear canal of a user, the one or more earbuds being connected electrically via connection wires that connect to a control enclosure and an energy storage enclosure, wherein the control enclosure and the energy storage enclosure are connected to each other via one or more connection wires. In some implementations, the control enclosure includes one or more control buttons to pause audio playback, to start audio playback, to link to a Bluetooth device, to increase volume or to decrease volume.

In some implementations, each of the one or more earbuds includes a first section and a second section, and the first section is smaller than the second section. In some implementations, each earbud is marked with an identifying mark placed on a shaft of the earbud to indicate a top of the earbud and to provide a visual guide for a user to position the earbud in an ear of the user.

In some implementations, the one or more integrated earbuds include a first earbud and a second earbud. In some implementations, the first earbud and the second earbud help block out external noise. In some implementations, the first earbud and the second earbud are constructed to fit inside respective ear canals of a user.

In some implementations, the first earbud is coupled via a wired connection to the control enclosure. In some implementations, the second earbud is coupled via a wired connection to the energy storage enclosure.

Some implementations can include a pair of earbuds that provide high quality delivery of music to a user via a wired or a Bluetooth connection.

Some implementations may be ideal for users who are very active and do not want the frustration of needing to readjust or re-insert earbuds or headphones every few minutes. Some implementations can provide one or more benefits or advantages described herein because the entire speaker sits comfortably inside the ear canal.

Some implementations can include a wired or Bluetooth ear phone that comfortably fits inside the ear canal of a user so the user can listen to music, phone calls or other audio programming without having to worry about the earbuds falling out while the user is active.

Some implementations can be constructed to enclose a miniature balanced speaker with magnetic radiation shielding for use in-the-ear (ITE). The speaker features a receiver that has a positive voltage applied to the negative terminal that results in an increase in pressure at the sound outlet. In some implementations, the speaker is connected with the speaker wire and enclosed within the silicon earplug. This type of speaker provides an ideal design for ITE and/or Behind the Ear (BTE) applications while giving the user high quality sound. The construction of the speaker can provide outstanding efficiency with maximum output. In some implementations, the speaker may be constructed with acoustic tubing that may use an exemplary 10.0 mm of 1.0 mm diameter of tubing that is then connected to an acoustic coupler providing the listener with the great sound from a compact speaker. The high quality silicon bud is designed to enclose an exemplary CSR 4.1 Bluetooth speaker with an IPX6 waterproof rating for robust design. Other ratings may be used as well. The design also provides the user with a built-in microphone to answer incoming telephone calls, etc.

Snug phones may offer an advantage over current technology in the way the snug phones speaker fits inside of the ear. The improvements described herein may provide high quality sound from the speaker and positions the earbud to reduce a need for the user to adjust the earbud while doing vigorous activities. The described improvement also creates a barrier against outside sound.

Conventional ear phones may have a larger speaker that does not fit well inside of the ear canal of a user. The conventional speaker is fastened to the outside of the earbud that is then placed inside of the ear causing a side heavy situation that can cause the ear phone to fall out of place easily and also may not be capable of delivering sound from where it is most effective. In conventional ear buds there is not a complete seal within the ear canal which may hinder an ability to block outside sound.

Snug Phones can be used in a variety of exercises comfortably. For example, jumping, skipping, running, sprinting, weightlifting, cross fit, body building, yard work, mowing the grass, skiing, snowboarding, and/or motorcycle riding, among many others.

Any sport or activity that requires a helmet close to the ear may benefit from snug phones, which can provide a very desirable option. Conventional headphones may fall out of the ear, putting the user at risk of taking their attention off the task at hand and having to readjust their headphones.

### BRIEF DESCRIPTION OF THE DRAWINGS

FIG. 1 is a diagram of an example improved audio system in accordance with some implementations.

FIG. 2 is a diagram of an example improved audio system in accordance with some implementations.

FIG. 3A is a diagram showing a side view of example earbuds of an improved audio system that features elements to help prevent the earbuds from falling out in accordance with some implementations.

FIG. 3B is a diagram showing an oblique view of example earbuds featuring elements to help prevent the earbuds from falling out in accordance with some implementations.

FIG. 4 is a diagram showing a cut-away, side view of example earbuds in accordance with some implementations.

FIG. 5 is a diagram showing an oblique shaded view of example earbuds in accordance with some implementations.

FIG. 6 is a diagram showing a transparent oblique view of example earbuds in which the speaker is situated well within the earbud of a wearer in accordance with some implementations.

FIG. 7 is a diagram showing a transparent front oblique view of example earbuds in accordance with some implementations.

### DETAILED DESCRIPTION

The term “snug phones” as used herein shall refer to earbuds, ear buds, In the Ear (ITE), earphones, or the like. Snug phones can include a small ITE earbud that is designed to remain in the ear during activity as well as small enough to be wearable with helmets. The above terms may be used interchangeably to describe the subject matter referred to as snug phones.

The term Bluetooth shall refer to Bluetooth or any other suitable wireless communication protocol for the purpose of transmitting the signal from device to the snug phones. The technology of Bluetooth may be replaced by any wireless protocol that may come into general practice. There may be a communication protocol that additionally provides the necessary power to run the snug phones as well. In some implementations, the design could also be manufactured with a wire that connected as a headphone jack rather than be made into a Bluetooth model. The headphones could derive their power from the music device rather than a battery (e.g., as attached to the Bluetooth model).

Some implementations can include integrated earbuds that features elements that prevent the earbuds from falling out of the ear by virtue of being light weight, fully inserted into the ear canal, and having the speakers well within the ear canal.

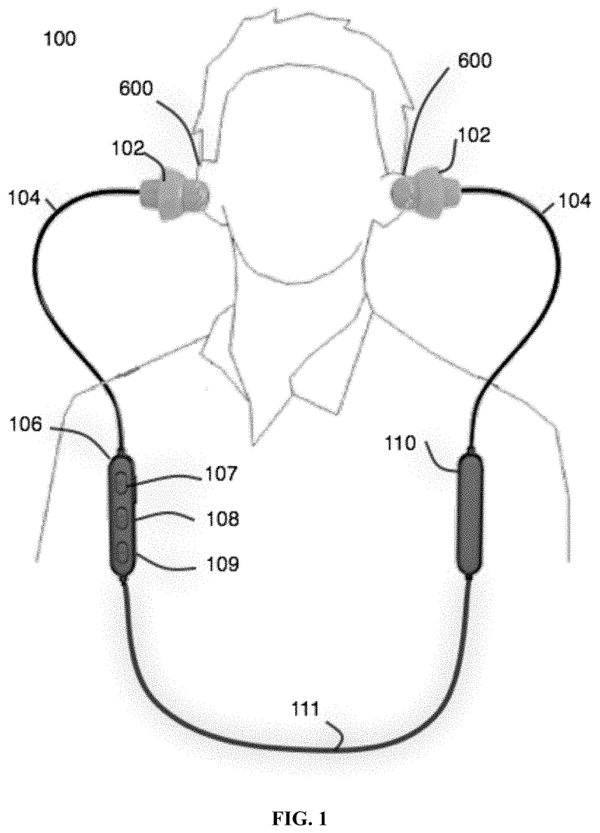

FIG. 1 shows an improved audio system 100 (e.g., snug phones) including integrated earbuds 102 having features that help prevent the earbuds 102 from falling out of the ear 600 by virtue of being light weight, fully inserted into the ear canal, and having the speakers well within the ear canal. The earbuds 102 are connected electrically via connection wires 104 that then connect to the control enclosure 106 and energy storage enclosure 110. These two elements are connected via connection wire 111. Within the control enclosure 106 there are a number of control buttons 107, 108, and 109 that can be used to pause, start, link Bluetooth, increase volume or decrease volume, etc. These buttons may be arranged in any way so as to be intuitive for the end user in the country of use.

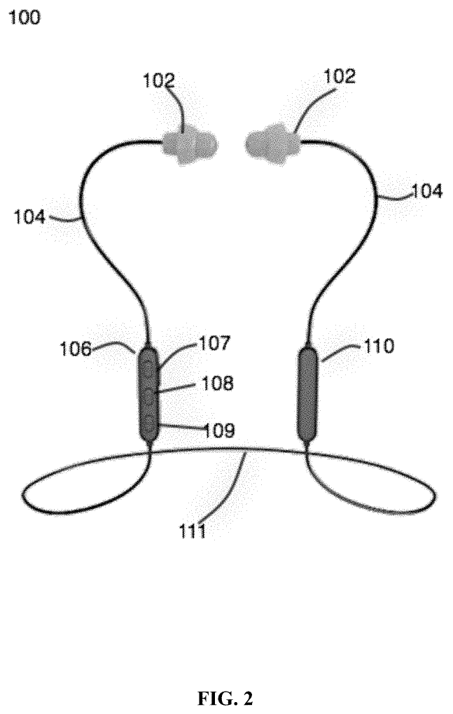

FIG. 2 illustrates an improved audio system including an integrated earbud that features elements that prevent the earbuds from falling out of the ear by virtue of being light weight, fully inserted into the ear canal and having the speakers within the ear canal. The earbuds 102 are connected electrically via connection wires 104 that then connect to the control enclosure 106 and energy storage enclosure 110. These two elements are connected via connection wire 111. Within the control enclosure 106 there are a number of control buttons 107, 108, and 109 that can be used to pause, start, link Bluetooth, increase volume or decrease volume. These buttons may be arranged in any way so as to be intuitive for the end user in the country of use.

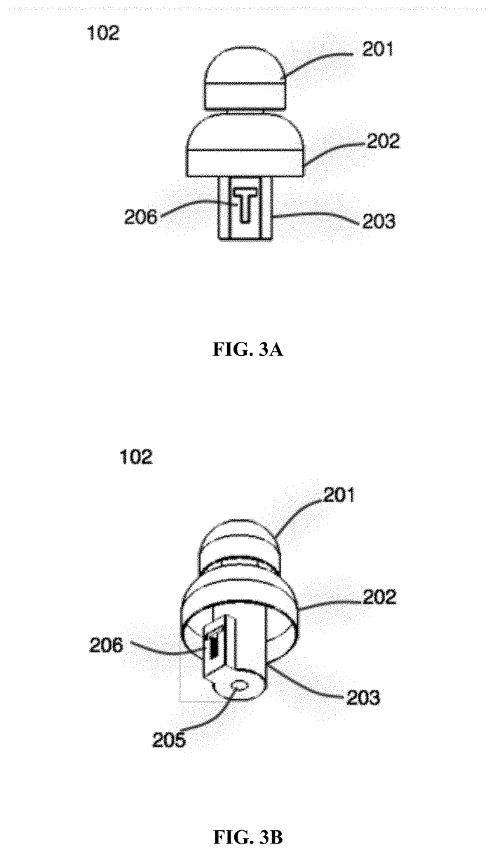

FIG. 3A illustrates the side view of the earbud 102 of an improved audio system that features elements that prevent the earbuds 102 from falling out. The earbud 102, features elements to allow it to fit securely within the ear canal. There is a smaller section 201 as well as a larger section 202 that provide the necessary flexibility to fit within the ear canal of a vast majority of users compared to conventional designs. In some implementations, the smaller bud fits deeper into the ear canal while the larger part of the bud would fit in the larger opening of the ear canal, making a snug fit within the ear canal, and easy to slide into place. The earbud 102 may be marked with an identifying mark 206, shown as a capital “T” in the figure that may be placed on the shaft 203 of the earbud 102. The “T” is to indicate Top. In use, a user can position the earbuds such that the T is facing the top of the ear, for easy insertion. FIG. 3B illustrates an oblique view of the earbud of an improved audio system that features elements that prevent the earbuds from falling out. The earbud 102, features elements to allow it to fit securely within the ear canal. There is a smaller section 201 as well as a larger section 202 that provide the necessary flexibility to fit within the ear canal of a vast majority of users compared to conventional designs. The earbud 102 has the wire entry point 205 shown that indicates the relative size of the cable to the shaft 203. The earbud 102 may be marked with an identifying mark 201, shown as a capital “T” in the figure that may be placed on the shaft 203 of the earbud 102.

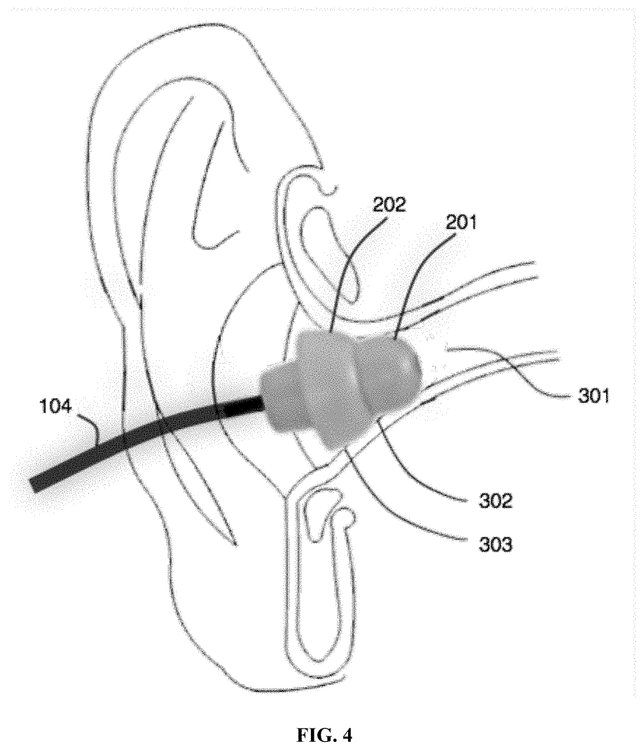

FIG. 4 illustrates the cut-away, side view of the earbud 102 of an improved audio system inserted into the ear canal of the user that features elements that prevent the earbuds from falling out. Shown in the earbud 102 is a smaller section 201 that fits within the smaller section 302 of the ear canal as well as a larger section 202 that fits within the larger section of the ear canal 303 that provides the necessary flexibility to fit within the ear canal 301 of a vast majority of users compared to conventional designs. The speaker hole 206 can be seen that is directed into the ear canal 301.

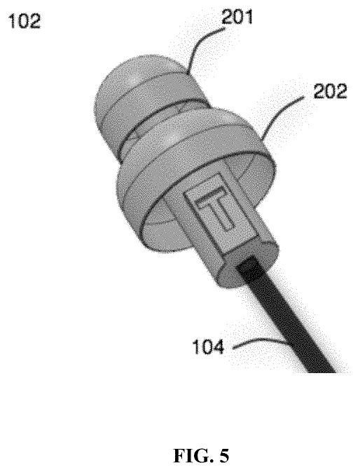

FIG. 5 illustrates an oblique shaded view of the earbud 102 of an improved audio system with the small connecting cable 104 that features elements that prevent the earbuds 102 from falling out of the ear canal. The smaller section 201 is shown and the reader can appreciate the profile to understand how this section will compress to fit within the ear canal. As well the larger section 202 is shown that provides elements that prevent the earbud 102 from falling out of the ear canal.

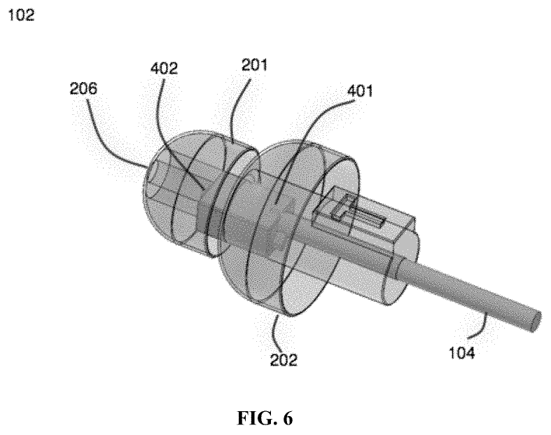

FIG. 6 illustrates a side transparent oblique view of the earbud 102, showing the speaker 401 well within the earbud 102 of an improved audio system that features elements with the small connecting cable that prevent the earbuds 102 from falling out. The speaker 401 includes improvements over conventional art is that speaker 401 is very small, affording the ability to mold it within the earbud 102. The speaker outlet 402 can be seen directed into the earbud speaker hole 206.

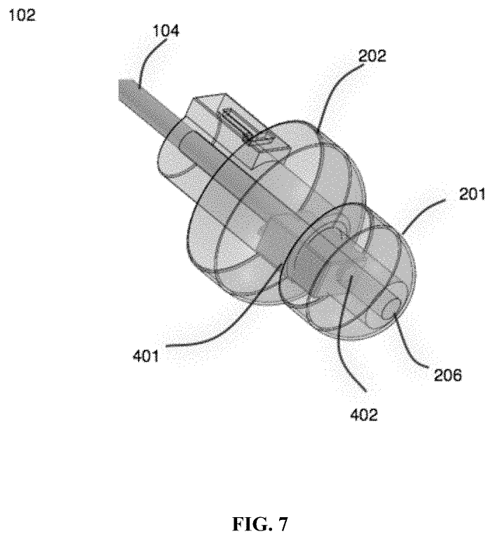

FIG. 7 illustrates a front view transparent oblique view of the earbud 102, showing the speaker 401 well within the earbud 102 of an improved audio system that features elements with the small connecting cable that prevent the earbuds 102 from falling out. The speaker 401 improvements over conventional art include the speaker 401 being constructed to be very small compared to some conventional speakers to affording the ability to mold it within the earbud 102. The speaker outlet 402 can be seen directed into the earbud speaker hole 206. In some implementations, one advantage of the speakers is size, with micro components the speakers can fit into a small opening such as an ear canal.

The drawings above describe to one skilled in the art how to manufacture the described matter. It should now be clear from the drawing descriptions the improvements over conventional art. It is important to note that conventional earbuds are typically large and by virtue of the speaker design may not fit in the ear. It can be seen from FIG. 6 that the speaker fits within the earbud 102. This technology has been heretofore unavailable in a commercially available speaker system.

Conventional earbuds have the speaker located outside of the ear and as a result have no proclivity to stay in, no matter what apparatus may be utilized to retain them.

Conventional earbuds are also, by the design of the speaker heavy. As such, these have a good deal of inertia when the user moves their head that acts to “shake” the earbud out of the ear. The improvements described herein address the shortcomings of conventional designs by virtue of the use of a small speaker as well as the novel placement of the small speaker within the earbud assembly that fits entirely within the ear canal.

Some implementations can include a fully self contained speaker, Bluetooth transmitter, and power source that can be recharged using induction charging technology. As well, further improvements on Bluetooth wireless communication protocols may be realized that can result in an ear but that fits within the ear canal of the uses and have sufficient power to deliver the desired sound quality and sound levels while still remaining securely within the ear canal and not fall out as conventional ear buds.

It is contemplated that any optional feature of the variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item.

The disclosed subject matter is not intended to be limited by the examples provided herein. The disclosed subject matter may have many variations explicitly or implicitly described herein, including those variations that would be obvious to one of ordinary skill in the art upon reading the present specification. Further, it is not intended that any section of this specification (e.g., the Summary, Detailed Description, Abstract, Field, etc.) be accorded special significance. All references cited are incorporated by reference in their entirety. Although the foregoing disclosed subject matter has been described in detail for purposes of clarity of understanding, it is contemplated that certain modifications may be practiced within the scope of the disclosed subject matter.

Some implementations can be constructed to enclose a miniature balanced speaker with magnetic radiation shielding for use in-the-ear (ITE). The speaker features a receiver that has a positive voltage applied to the negative terminal that results in an increase in pressure at the sound outlet. In some implementations, the speaker is connected with the speaker wire and enclosed within the silicon earplug. This type of speaker provides an ideal design for ITE and/or Behind the Ear (BTE) applications while giving the user high quality sound. The construction of the speaker can provide outstanding efficiency with maximum output. In some implementations, the speaker may be constructed with acoustic tubing that may use an exemplary 10.0 mm of 1.0 mm diameter of tubing that is then connected to an acoustic coupler providing the listener with the great sound from a compact speaker. The high quality silicon bud is designed to enclose an exemplary CSR 4.1 Bluetooth speaker with an IPX6 waterproof rating for robust design. Other ratings may be used as well. The design also provides the user with a built-in microphone to answer incoming telephone calls, etc.

It is, therefore, apparent that there is provided, in accordance with the various embodiments disclosed herein, an improved earphone system.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. An earphone system comprising:
a first earphone;
a second earphone;
a control enclosure; and
an energy storage enclosure,
wherein the first earphone is coupled to the control enclosure,
wherein the second earphone is coupled to the energy storage enclosure,
wherein the control enclosure is coupled to the energy storage enclosure,
wherein a first wire coupled to the first earphone and a second wire coupled to the second earphone are disposed on an outside of each earphone,
wherein a speaker within each of the first earphone and second earphone fit directly into the ear canal of a user resulting in an earphone that does not have any elements outside a portion that is disposed within the ear canal of the user, and which results in a very stable earbud that is firmly held in place in the ear canal of the user.

2. The earphone system of claim 1, wherein the first earphone and the second earphone help block out external noise.

3. The earphone system of claim 1, wherein the first earphone and the second earphone are constructed to fit inside respective ear canals of a user.

4. The earphone system of claim 1, wherein the first earphone is coupled via a wired connection to the control enclosure.

5. The earphone system of claim 1, wherein the second earphone is coupled via a wired connection to the energy storage enclosure.

6. An earbud system comprising:
a first earbud;
a second earbud;
a control enclosure; and
an energy storage enclosure,
wherein the first earbud is coupled to the control enclosure,
wherein the second earbud is coupled to the energy storage enclosure,
wherein the control enclosure is coupled to the energy storage enclosure,
wherein a first wire coupled to the first earbud and a second wire coupled to the second earbud are disposed on an outside of the earbud,
wherein a speaker within each of the first earbud and second earbud fit directly into the ear canal of a user resulting in an earbud that does not have any elements outside a portion that is disposed within the ear canal of the user, and which results in a very stable earbud that is firmly held in place in the ear canal of the user.

7. The earbud system of claim 6, wherein the first earbud and the second earbud help block out external noise.

8. The earbud system of claim 6, wherein the first earbud and the second earbud are constructed to fit inside respective ear canals of a user.

9. The earbud system of claim 6, wherein the first earbud is coupled via a wired connection to the control enclosure.

10. The earbud system of claim 6, wherein the second earbud is coupled via a wired connection to the energy storage enclosure.

11. An audio system comprising:
one or more integrated earbuds constructed to be fully inserted into an ear canal of a user, the one or more earbuds being connected electrically via connection wires that connect to a control enclosure and an energy storage enclosure, wherein the control enclosure and the energy storage enclosure are connected to each other via one or more connection wires, and
wherein the control enclosure includes one or more control buttons to pause audio playback, to start audio playback, to link to a Bluetooth device, to increase volume or to decrease volume.

12. The audio system of claim 11, wherein each of the one or more earbuds includes a first section and a second section, wherein the first section is smaller than the second section.

13. The audio system of claim 11, wherein each earbud is marked with an identifying mark placed on a shaft of the earbud to indicate a top of the earbud and to provide a visual guide for a user to position the earbud in an ear of the user.

14. The audio system of claim 11, wherein the one or more integrated earbuds include a first earbud and a second earbud.

15. The audio system of claim 14, wherein the first earbud and the second earbud help block out external noise.

16. The audio system of claim 14, wherein the first earbud and the second earbud are constructed to fit inside respective ear canals of a user.

17. The audio system of claim 14, wherein the first earbud is coupled via a wired connection to the control enclosure.

18. The audio system of claim 14, wherein the second earbud is coupled via a wired connection to the energy storage enclosure.
